(19) United States
(12) Patent Application Publication
(10) Pub. No.: US 2021/0401210 A1
(43) Pub. Date: Dec. 30, 2021

(54) SMART HEATED FLOOR RUNNER

(71) Applicant: Dione Reicks-Berry, Urbandale, IA (US)

(72) Inventor: Dione Reicks-Berry, Urbandale, IA (US)

(21) Appl. No.: 16/911,662

(22) Filed: Jun. 25, 2020

(51) Int. Cl. A47G 27/02; H05B 1/02; H05B 3/34

(52) U.S. Cl. CPC A47G 27/0243; H05B 1/0277; H05B 2203/003; A47G 27/0212; H05B 2203/026; H05B 3/34

(57) ABSTRACT

The present invention is a plush heat up runner with features including: Bluetooth smart app, voice control, lights, timer auto turn off, and battery powered. Heating coils are inside the runner to provide warmth to the user and also facilitate safety against spills and pet damage. The heat up runner suctions to the floor to resist shifting while a person walks on it. A user may control settings on the runner by using the accompanying app or the voice control feature. A method includes straightening a single scroll for heating via a substrate having a length, a width and a thickness, the substrate initially rolled up into a single scroll. The method also includes running a scrollable grid of internal heating coils, having an angular relation to each other, along a portion of the length and a portion of the width of the substrate within the thickness of the substrate.

### BACKGROUND

Many home owners, mobile home owners, RV owners, popup camper owners, and others have cold floors such as in bathrooms, kitchens, garages or patios. To have a heated mat or runner to warm your path to your destination like a sink, shower or toilet would be great any time of year and night. There have been no products available as original equipment or as an aftermarket to address this problem.

A mat is a piece of fabric material place on the floor or another flat surface. Mats have a variety of uses including: to clean items passed over it (a doormat), to protect persons or items over it from a hard or rough surface underneath, to protect what is underneath the mat (a place mat on a table, or matting in archival records), and to provide a regular or flat cushioned surface. A mat may be used in the home to soak up small amounts of water such as a bath mat, to warm a surface, or to provide comfort or ergonomic support for sustained positions such as standing at a desk, kitchen, or work bench.

There exists a need for a heated Bluetooth enabled floor runner that is not being met by any known or disclosed device or system of present.

### SUMMARY OF THE INVENTION

The present invention is a plush heat up runner with features including: Bluetooth smart app, voice control, lights, timer auto turn off, and battery powered. Heating coils are inside the runner to warm the surface of the runner during use and to facilitate safety for possible spills or pet damage. The heat up runner suctions to the floor to resist shifting while a person walks on it. A user may control settings on the runner by using the accompanying app or the voice control feature.

### BRIEF DESCRIPTION OF THE DRAWINGS

FIG. 1 depicts the runner in full extension position or in use position in accordance with an embodiment of the present disclosure.

FIG. 2 depicts the runner in a rolled up position in accordance with an embodiment of the present disclosure.

FIG. 3 depicts a runner carrying case or bag in accordance with an embodiment of the present disclosure.

FIG. 4 depicts a flow chart of a method for heating via a smart heated floor runner in accordance with an embodiment of the present disclosure.

FIG. 5 depicts another flow chart of a method for constructing and using the smart heated floor runner in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

Throughout the present disclosure the term runner is used to refer to a piece of fabric material that is placed on the floor, like a rug or mat, that is long and narrow. Runners are commonly used on staircases, narrow hallways, bedrooms, the entrance of a home, the kitchen, and in front of the sink.

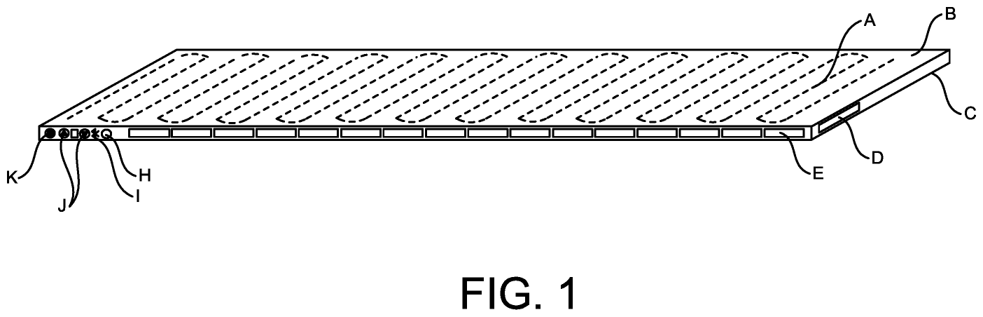

FIG. 1 depicts the runner in full extension position or in use position in accordance with an embodiment of the present disclosure. The runner contains internal heating coils A that warm up the surface of the mat to be warm to the touch. The present invention is a cushioned warm runner B. The runner comes in different sizes, colors and designs with a non-slip textured surface made of a kid and pet friendly material. Bottom side of the mat C suctions to the floor to avoid mat slipping and possible injury to users. On the side edge, perpendicular to the floor, is a rechargeable battery compartment D. The outside long edges of the mat light up E.

In an embodiment of the disclosure, the mat has several buttons on the side edge, perpendicular to the floor. The invention contains a voice control feature H, a Bluetooth connect button I where the mat may be controlled by an app on the user's smart phone, a temperature control feature J where an up and a down button may vary the temperature that the mat heats to, and a power button K to turn the heat function on the mat on and off. The runner also has lights along the vertical edges to light up the path.

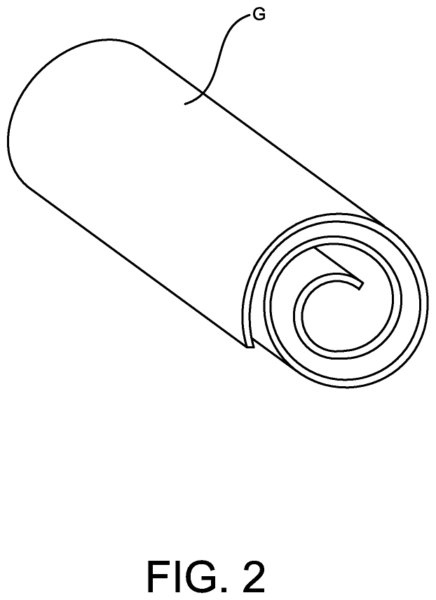

FIG. 2 depicts the runner in a rolled up position in accordance with an embodiment of the present disclosure. The runner in this position may be stored rolled up or temporarily moved out of use.

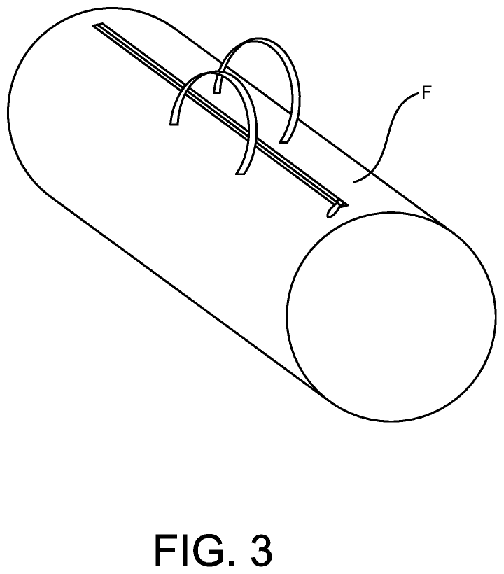

FIG. 3 depicts a runner carrying case or bag in accordance with an embodiment of the present disclosure. The bag has two handles for carrying and a long zipper through which the runner may be placed in or taken out. The bag makes carrying, moving, and storing the runner easy.

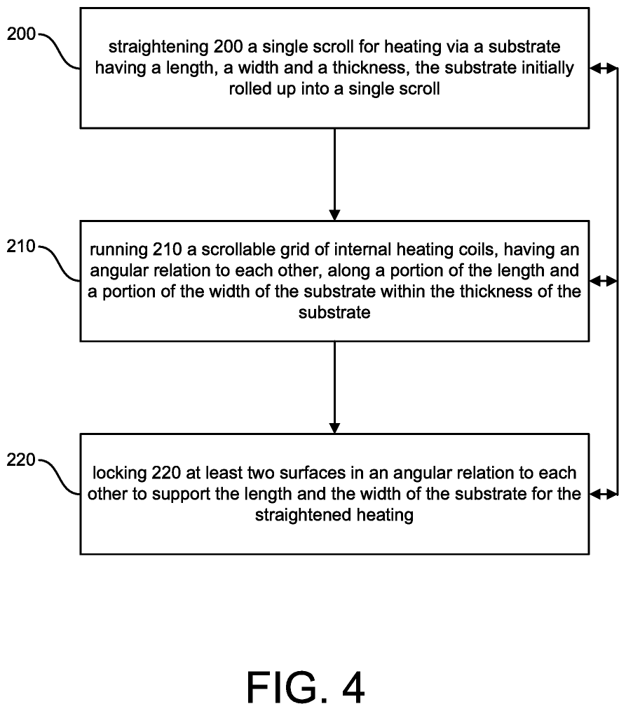

FIG. 4 depicts a flow chart of a method for heating via a smart heated floor runner in accordance with an embodiment of the present disclosure. The method includes straightening 200 a single scroll for heating via a substrate having a length, a width and a thickness, the substrate initially rolled up into a single scroll. The method also includes running 210 a scrollable grid of internal heating coils, having an angular relation to each other, along a portion of the length and a portion of the width of the substrate within the thickness of the substrate. The method additionally includes locking 220 at least two surfaces in an angular relation to each other to support the length and the width of the substrate for the straightened heating.

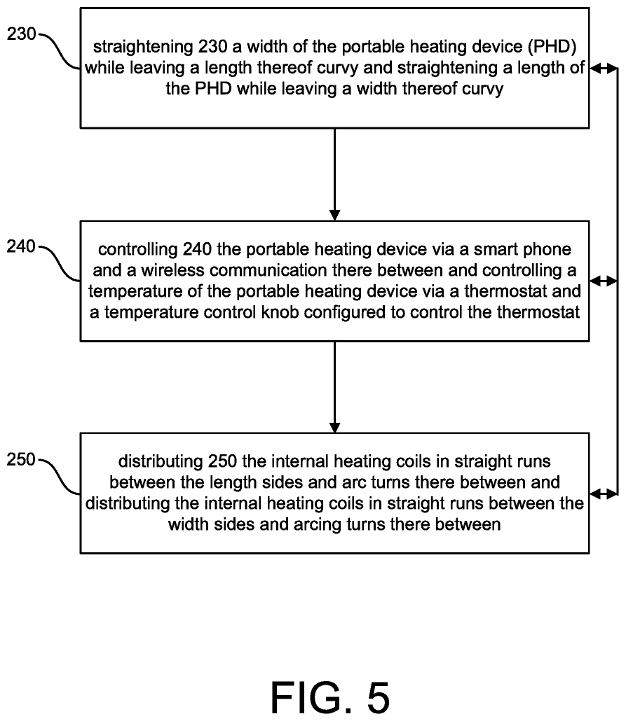

FIG. 5 depicts another flow chart of a method for constructing and using the smart heated floor runner in accordance with an embodiment of the present disclosure. The method includes scrolling the substrate along a long edge of the substrate and scrolling the substrate along a short edge of the substrate. Embodiments also include straightening 230 a width of the display while leaving a length of the display curvy and straightening a length of the display while leaving a width of the display curvy. Embodiments of the method additionally include controlling 240 the portable heating device via a smart phone and a wireless communication there between and controlling a temperature of the portable heating device via a thermostat and a temperature control knob configured to control the thermostat. Furthermore, embodiments include lighting the portable heating device via a plurality of light emitting diode panels disposed on the substrate thickness. Embodiments yet include distributing 250 the internal heating coils in straight runs between the length sides and arc turns there between and distributing the internal heating coils in straight runs between the width sides and arcing turns there between.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

While the forgoing examples are illustrative of the principles of the present disclosure in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the disclosure be limited, except as by the specification and claims set forth herein.

What is claimed is:

1. A heating device, comprising:
a. a substrate having a length, a width and a thickness, the substrate initially rolled up into a single scroll and straightened for heating;
b. a scrollable grid of internal heating coils having an angular relation to each other and running a portion of the length and a portion of the width of the substrate within the thickness of the substrate; and
c. at least two surfaces in an angular relation to each other configured to support the length and the width of the substrate for the straightened heating.

2. The heating device of claim 1, further comprising a thermostat and a temperature control knob configured to control the thermostat.

3. The heating device of claim 1, further comprising a plurality of light emitting diode panels disposed on the substrate thickness.

4. The heating device of claim 1, further comprising at least one LED (light emitting diode) light strip disposed on the substrate thickness.

5. The heating device of claim 1, further comprising a controller activated by voice and in communication with a thermostat and a lighting in the heating device.

6. The heating device of claim 1, further comprising a rechargeable battery compartment as a power source for the internal heating coils.

7. The heating device of claim 1, further comprising a wireless control of the heating device via a smart phone.

8. The heating device of claim 1, further comprising a non-slip textured surface configured to lay adjacent a smooth flooring.

9. The heating device of claim 1, further comprising a cushioned surface configured on a top surface parallel with a bottom surface adjacent a flooring.

10. The heating device of claim 1, further comprising a cylindrical containment bag for the heating device in a scrolled up configuration.

11. A method for heating via a portable heating device, the method comprising:
a. straightening a single scroll for heating via a substrate having a length, a width and a thickness, the substrate initially rolled up into a single scroll;
b. running a scrollable grid of internal heating coils, having an angular relation to each other, along a portion of the length and a portion of the width of the substrate within the thickness of the substrate; and
c. locking at least two surfaces in an angular relation to each other to support the length and the width of the substrate for the straightened heating.

12. The method of claim 11, further comprising scrolling the substrate along a long edge of the substrate.

13. The method of claim 11, further comprising scrolling the substrate along a short edge of the substrate.

14. The method of claim 11, further comprising straightening a width of the display while leaving a length of the display curvy.

15. The method of claim 11, further comprising straightening a length of the display while leaving a width of the display curvy.

16. The method of claim 11, further comprising controlling the portable heating device via a smart phone and a wireless communication there between.

17. The method of claim 11, further comprising controlling a temperature of the portable heating device via a thermostat and a temperature control knob configured to control the thermostat.

18. The method of claim 11, further comprising lighting the portable heating device via a plurality of light emitting diode panels disposed on the substrate thickness.

19. The method of claim 11, further comprising distributing the internal heating coils in straight runs between the length sides and arc turns there between.

20. The method of claim 11, further comprising distributing the internal heating coils in straight runs between the width sides and arcing turns there between.
